(19) United States
(12) Patent Application Publication
(10) Pub. No.: US 2016/0211974 A1
(43) Pub. Date: Jul. 21, 2016

(54) DATA GENERATION APPARATUS, COMMUNICATION APPARATUS, COMMUNICATION SYSTEM, MOBILE OBJECT, DATA GENERATION METHOD, AND COMPUTER PROGRAM PRODUCT

(71) Applicant: KABUSHIKI KAISHA TOSHIBA, Tokyo (JP)

(72) Inventors: Yuichi KOMANO, Yokohama (JP); Takeshi KAWABATA, Kawasaki (JP); Hideo SHIMIZU, Kawasaki (JP)

(21) Appl. No.: 14/971,282

(22) Filed: Dec. 16, 2015

(30) Foreign Application Priority Data
Jan. 16, 2015 (JP) 2015-006654

(51) Int. Cl. H04L 9/08; G06F 21/75

(52) U.S. Cl. CPC H04L 9/0894; H04L 9/0861; G06F 21/75

(57) ABSTRACT

According to an embodiment, a data generation apparatus includes a first generator, a first determination unit, an acquisition unit, a second generator, and a storage controller. The first generator generates first data unique to an apparatus. The first determination unit determines whether acquisition of second data is necessary according to a predetermined condition. The acquisition unit acquires the second data from an outside of the apparatus when it is determined that acquisition of the second data is necessary. The second generator generates third data by using the first data and the second data. The storage controller stores, into a storage, the second data that has been used for generation of the third data. When it is determined that acquisition of the second data is not necessary, the second generator generates the third data by using the first data and the second data stored in the storage.

### CROSS-REFERENCE TO RELATED APPLICATION(S)

This application is based upon and claims the benefit of priority from Japanese Patent Application No. 2015-006654, filed on Jan. 16, 2015; the entire contents of which are incorporated herein by reference.

### FIELD

An embodiment described herein relates generally to a data generation apparatus, a communication apparatus, a communication system, a mobile object, a data generation method, and a computer program product.

### BACKGROUND

There is a technique to generate data with high confidentiality, such as an identifier used for authentication processing or an encryption key used for encryption communication, by using a physically unclonable function (PUF). The PUF is a technique to derive unique data of an apparatus by using a production tolerance in semiconductor production. Generally, even when the same input is given to the same PUF, an output from the PUF includes some errors depending on execution environment such as voltage or a temperature. Thus, by using data calculated by an error correction technique or a Fuzzy Extractor, object data such as an identifier or an encryption key is generated correctly from an output, which includes some errors, from the PUF. The output from the PUF is unique data of an apparatus. However, by using data adjusted to absorb a difference between outputs from PUFs of a plurality of apparatuses, it is also possible to generate, from the outputs from the PUFs, data such as a shared key which data is shared by the plurality of apparatuses.

Hereinafter, data which is unique to an apparatus and which is generated by using a PUF or the like is referred to as “first data”. Data used to generate object data such as an identifier or an encryption key from the first data will be referred to as “second data”. Data such as an identifier or an encryption key generated by using the first data and the second data will be referred to as “third data”.

When a configuration in which second data used for generation of third data is acquired from the outside of an apparatus is included, a configuration of the apparatus becomes simple and a production cost can be reduced. However, when the second data is acquired from the outside of the apparatus each time processing, which uses third data, such as authentication using an identifier or encryption communication using an encryption key is executed, a communication cost is increased and a long period of time is spent until the processing using the third data is executed.

### BRIEF DESCRIPTION OF THE DRAWINGS

FIG. 1 is a block diagram illustrating a configuration example of a data generation apparatus of a first embodiment;

FIG. 2 is a flowchart illustrating a processing procedure in the data generation apparatus of the first embodiment;

FIG. 3 is a block diagram illustrating a configuration example of a data generation apparatus of a second embodiment;

FIG. 4 is a flowchart illustrating a processing procedure in the data generation apparatus of the second embodiment;

FIG. 5 is a schematic configuration view illustrating an example of a communication system;

FIG. 6 is a schematic configuration view illustrating a different example of a communication system; and

FIG. 7 is a schematic view illustrating an outline of a communication system mounted in an automobile.

### DETAILED DESCRIPTION

According to an embodiment, a data generation apparatus includes a first generator, a first determination unit, an acquisition unit, a second generator, and a storage controller. The first generator generates first data unique to an apparatus. The first determination unit determines whether acquisition of second data is necessary according to a predetermined condition. The acquisition unit acquires the second data from an outside of the apparatus when it is determined that acquisition of the second data is necessary. The second generator generates third data by using the first data and the second data. The storage controller stores, into a storage, the second data that has been used for generation of the third data. When it is determined that acquisition of the second data is not necessary, the second generator generates the third data by using the first data and the second data stored in the storage.

A data generation apparatus of an embodiment generates third data by using first data which is generated in an apparatus and is unique to the apparatus and second data acquired from the outside of the apparatus. In the present embodiment, data generated by using a PUF is assumed as first data which is generated in an apparatus and is unique to the apparatus. However, first data only needs to be data, which is generated in an apparatus and is unique to the apparatus, and is not limited to data generated by using the PUF. Alternatively, first data may be a value previously stored in an apparatus.

In the present embodiment, second data acquired from the outside of an apparatus may be data calculated by an error correction technique or a Fuzzy Extractor or data adjusted to absorb a difference between a plurality of pieces of first data generated in a plurality of apparatuses and to lead an intended value as above; however, this is not the limitation. In the present embodiment, the above-described identifier or encryption key (shared key) is assumed as third data generated by using first data and second data but this is not the limitation.

In a configuration of an embodiment in which third data is generated by using first data, which is generated in an apparatus and which is unique to the apparatus, and second data acquired from the outside of the apparatus, when the second data is acquired from the outside of the apparatus each time processing using the third data is executed, a communication cost is increased and a long period of time is spent until processing using the third data is executed. Thus, in a data generation apparatus of the embodiment, second data previously-used for generation of third data is stored into a storage and it is determined whether acquisition of second data is necessary when processing using third data is executed next. Then, when it is determined that acquisition of second data is necessary, the second data is acquired from the outside of the apparatus and third data is generated by using the second data. On the other hand, when it is determined that acquisition of second data is not necessary, third data is generated by using second data stored in the storage. In such a manner, instead of acquiring second data from the outside of the apparatus each time processing using third data is executed, it is determined whether acquisition of second data is necessary and the second data is acquired from the outside of the apparatus only when it is determined that acquisition is necessary. Thus, it is possible to generate third data in a short period of time and to reduce a period of time spent until processing using the third data is executed.

It is determined whether acquisition of second data is necessary according to a predetermined condition. For example, when second data is not stored in the storage, it is determined that acquisition of second data is necessary. Even when second data is stored in the storage, in a case where a predetermined period of time has passed since the second data is stored in the storage or in a case where the number of times of generation of third data by using the second data exceeds the predetermined number of times, stored second data is preferably updated. Thus, it is determined that acquisition of second data is necessary. These conditions are examples. It may be determined whether acquisition of second data is necessary according to a different condition.

In the following, a detail example of a data generation apparatus of an embodiment will be described in detail with reference to the drawings.

### First Embodiment

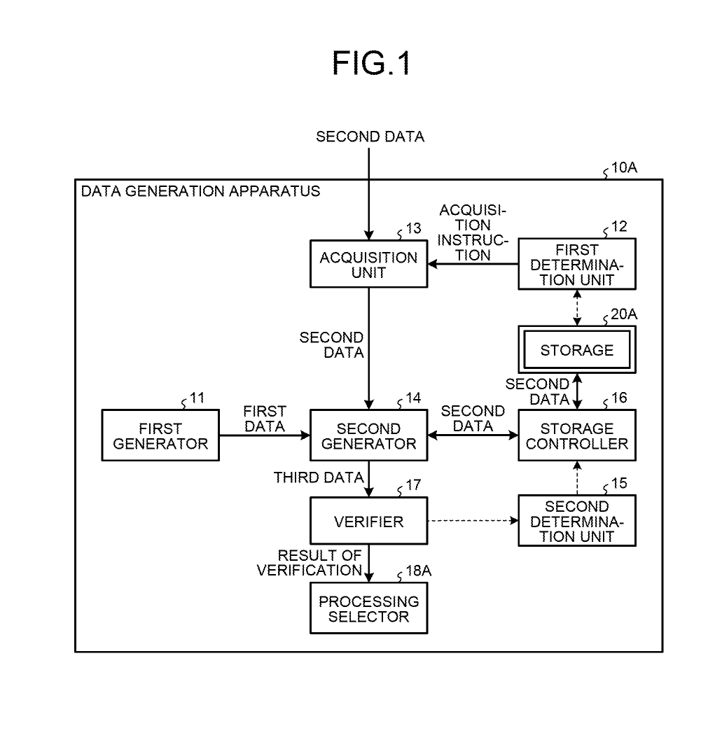

FIG. 1 is a block diagram illustrating a configuration example of a data generation apparatus 10A of the first embodiment. As illustrated in FIG. 1, the data generation apparatus 10A includes a first generator 11, a first determination unit 12, an acquisition unit 13, a second generator 14, a second determination unit 15, a storage controller 16, a verifier 17, and a processing selector 18A. In the data generation apparatus 10A, a storage 20A is provided. Note that in the present embodiment, an example in which the storage 20A is provided in the data generation apparatus 10A is assumed. However, the storage 20A may be provided outside of the data generation apparatus 10A as long as the storage 20A is provided in an apparatus (such as first communication apparatus 100 described later) including the data generation apparatus 10A.

The first generator 11 generates first data unique to an apparatus. The first data generated by the first generator 11 is not always the same data and may include a small error each time being generated. As the first generator 11, for example, an SRAM-PUF using an initial value of a static RAM (SRAM) or an Arbiter-PUF using a signal delay of a circuit can be used.

The first determination unit 12 determines whether acquisition of second data is necessary according to a predetermined condition. For example, when no second data is stored in the storage 20A, the first determination unit 12 determines that acquisition of second data is necessary.

Even when second data is stored in the storage 20A, the first determination unit 12 determines that acquisition of second data is necessary, for example, in a case where a period of time passed since the second data is stored into the storage 20A exceeds a first threshold. A period of time which is optimal as an upper time limit to hold the same second data in an apparatus is set as the first threshold. By making the first threshold as large as possible, it is possible to reduce frequency of acquisition of second data from the outside of the apparatus.

Even when second data is stored in the storage 20A, the first determination unit 12 determines that acquisition of second data is necessary in a case where the number of times the second generator 14 generates third data by using the second data exceeds a second threshold. The number of times which is optimal as the upper limit of the number of times of generation of third data by using the same second data is set as the second threshold. By making the second threshold as large as possible, it is possible to reduce frequency of acquisition of second data from the outside of the apparatus.

Even when second data is stored in the storage 20A, the first determination unit 12 determine that acquisition of second data is necessary in a case where an instruction to acquire second data is received from the outside of the apparatus. For example, when a communication apparatus including the data generation apparatus 10A communicates with a different communication apparatus, there is a case where an instruction to acquire second data is transmitted from the different communication apparatus. In such a case, even when second data is stored in the storage 20A, the first determination unit 12 determines that acquisition of second data is necessary.

Even when second data is stored in the storage 20A, the first determination unit 12 determines that acquisition of second data is necessary in a case where a difference between statistical information such as an average or dispersion of first data, which is used for generation of third data immediately after the second data is stored into the storage 20A, and statistical information such as an average or dispersion of first data used for generation of recent third data exceeds a third threshold. That is, when it is determined that an error of first data which is generated by the first generator 11 and which is unique to an apparatus changes immediately after second data is stored into the storage 20A, acquisition of new second data becomes necessary. Thus, when there is a significant difference between statistical information of first data immediately after second data is stored into the storage 20A and statistical information of recent first data, the first determination unit 12 determines that acquisition of second data is necessary. As the third threshold, a value with which it is possible to identify there is a significant difference between two pieces of statistical information is set. By making the third threshold as large as possible, it is possible to reduce frequency of acquisition second data from the outside of the apparatus.

The acquisition unit 13 acquires second data from the outside of the apparatus when the first determination unit 12 determines that acquisition of second data is necessary. For example, when determining that acquisition of second data is necessary, the first determination unit 12 supplies, to the acquisition unit 13, an instruction to acquire second data. The acquisition unit 13 acquires second data from the outside of the apparatus according to the instruction of acquisition from the first determination unit 12. The second data acquired by the acquisition unit 13 is, for example, at least one of data used for error correction of first data generated by the first generator 11 or data used to absorb a difference between pieces of first data of a plurality of apparatuses and to generate common third data. The outside of the apparatus from which the acquisition unit 13 acquires second data is a different apparatus (such as second communication apparatus 200 described later) including a function to provide second data to the data generation apparatus 10A.

The second generator 14 generates third data by using first data and second data. The third data generated by the second generator 14 is, for example, an identifier used for authentication processing or an encryption key used for encryption communication. When the first determination unit 12 determines that acquisition of second data is necessary and the acquisition unit 13 acquires the second data from the outside of the apparatus, the second generator 14 generates third data by using the first data generated by the first generator 11 and the second data acquired by the acquisition unit 13 from the outside of the apparatus. On the other hand, when the first determination unit 12 determines that acquisition of second data is not necessary, the second generator 14 generates third data by using the first data generated by the first generator 11 and the second data stored in the storage 20A, that is, second data used for previous generation of third data. The second data stored in the storage 20A is read by the storage controller 16 from the storage 20A.

According to a predetermined condition, the second determination unit 15 determines whether to hold, in the apparatus, the second data which is acquired from the outside of the apparatus and which is used for generation of third data. For example, the second determination unit 15 determines not to hold the second data when it is not possible to hold operation time or consumed power to store the second data into the storage 20A. For example, when a period of time in which power is supplied to the data generation apparatus 10A is short or when it is necessary to perform processing with high priority after generation of third data, it is not possible to hold operation time to store the second data into the storage 20A. For example, when an amount of power supplied to the data generation apparatus 10A is small, it is not possible to receive consumed power to store the second data into the storage 20A. In such a case, the second determination unit 15 determines that second data which is acquired from the outside of the apparatus and which is used for generation of the third data is not to be held in the apparatus.

As a result of verification processing performed by the verifier 17, which will be described later, with respect to third data generated by the second generator 14 by using second data acquired from the outside of the apparatus, when it is determined that the third data is not correct, the second determination unit 15 determines that the second data used for generation of the third data is not to be held in the apparatus.

The storage controller 16 stores second data into the storage 20A or reads second data stored in the storage 20A. As described above, when the first determination unit 12 determines that acquisition of second data is not necessary, the storage controller 16 reads second data stored in the storage 20A according to a request from the second generator 14. When the second determination unit 15 determines that second data is to be stored in the apparatus, the storage controller 16 stores, into the storage 20A, second data used for generation of third data by the second generator 14.

The verifier 17 verifies correctness of the third data generated by the second generator 14. For example, by using a hash value of the third data, the verifier 17 can verify correctness of the third data generated by the second generator 14. That is, the verifier 17 calculates a hash value of the third data generated by the second generator 14 and compares the calculated hash value with a hash value previously-calculated as a hash value of third data determined to be correct. Then, when these hash values are not identical to each other, it is determined that the third data generated by the second generator 14 is not correct. The hash value of the third data determined to be correct may be previously stored in the storage 20A or the like or may be acquired from the outside of the apparatus when verification processing by the verifier 17 is performed.

By using an encrypted text, which is encrypted by using the third data, instead of a hash value of the third data, the verifier 17 may verify correctness of the third data generated by the second generator 14. In this case, the verifier 17 encrypts predetermined sample data and generates an encrypted text by using the third data generated by the second generator 14 and compares the generated encrypted text with an encrypted text which is sample data encrypted by using third data determined to be correct. Then, when these encrypted texts are not identical to each other, it is determined that the third data generated by the second generator 14 is not correct. Sample data or an encrypted text generated by using third data determined to be correct may be previously stored in the storage 20A or the like or may be acquired from the outside of the apparatus when verification processing by the verifier 17 is performed.

The verifier 17 may verify correctness of the third data, which is generated by the second generator 14, by a combination of the above-described verification using a hash value of the third data and verification using an encrypted text encrypted by using the third data.

When the verifier 17 determines that the third data generated by the second generator 14 is not correct, the processing selector 18A selects, according to a predetermined selection rule, at least one kind of processing among regeneration of first data, reacquisition of second data, and invalidation of the apparatus. Here, it is preferable that the processing selector 18A is likely to select regeneration of first data compared to reacquisition of second data. Accordingly, it can be made more difficult to perform an attack to infer first data or third data by repeatedly inputting falsified second data.

In the present embodiment, as one of selection rules, a rule to invalidate an apparatus when the number of times of verification failure exceeds the predetermined number of times is included. The number of times of verification failure is the total number of times the verifier 17 determines that third data generated by the second generator 14 is not correct. A condition in which the number of times of verification failure exceeds the predetermined number of times will be referred to as an invalidation condition in the following. When the verifier 17 determines that the third data generated by the second generator 14 is not correct, the processing selector 18A determines whether the invalidation condition is satisfied. When the invalidation condition is satisfied, invalidation of an apparatus is selected as the following processing. As a result, the data generation apparatus 10A is invalidated. Note that the above-described invalidation condition is an example and is not the limitation.

In the present embodiment, as one of selection rules, a rule to reacquire second data when the number of times of verification failure is equal to or smaller than the predetermined number of times and is a multiple number of a predetermined value is further included. A condition in which the number of times of verification failure is a multiple number of a predetermined value will be referred to as a second data reacquisition condition in the following. When the verifier 17 determines that the third data generated by the second generator 14 is not correct, the processing selector 18A determines whether the invalidation condition is satisfied. When the invalidation condition is not satisfied, it is further determined whether the second data reacquisition condition is satisfied. Then, when the second data reacquisition condition is satisfied, the processing selector 18A selects reacquisition of second data as the following processing. As a result, second data is reacquired and third data is newly generated by using the second data. In this case, regeneration of first data is performed along with reacquisition of second data. On the other hand, when the second data reacquisition condition is not satisfied, the processing selector 18A selects regeneration of first data as the following processing. As a result, first data is regenerated and third data is newly generated by using the first data. When regeneration of first data is selected, reacquisition of second data is not performed. Note that the above-described second data reacquisition condition is an example and is not the limitation.

Note that when reacquisition of second data is selected by the processing selector 18A, the acquisition unit 13 may acquire second data from the outside of the apparatus or the storage controller 16 may read second data stored in the storage 20A. When reacquisition of second data is selected by the processing selector 18A, the first determination unit 12 may determine whether acquisition of second data is necessary. When it is determined that acquisition of second data is necessary, the acquisition unit 13 may acquire second data from the outside of the apparatus. When it is determined that acquisition of second data is not necessary, the storage controller 16 may read second data stored in the storage 20A.

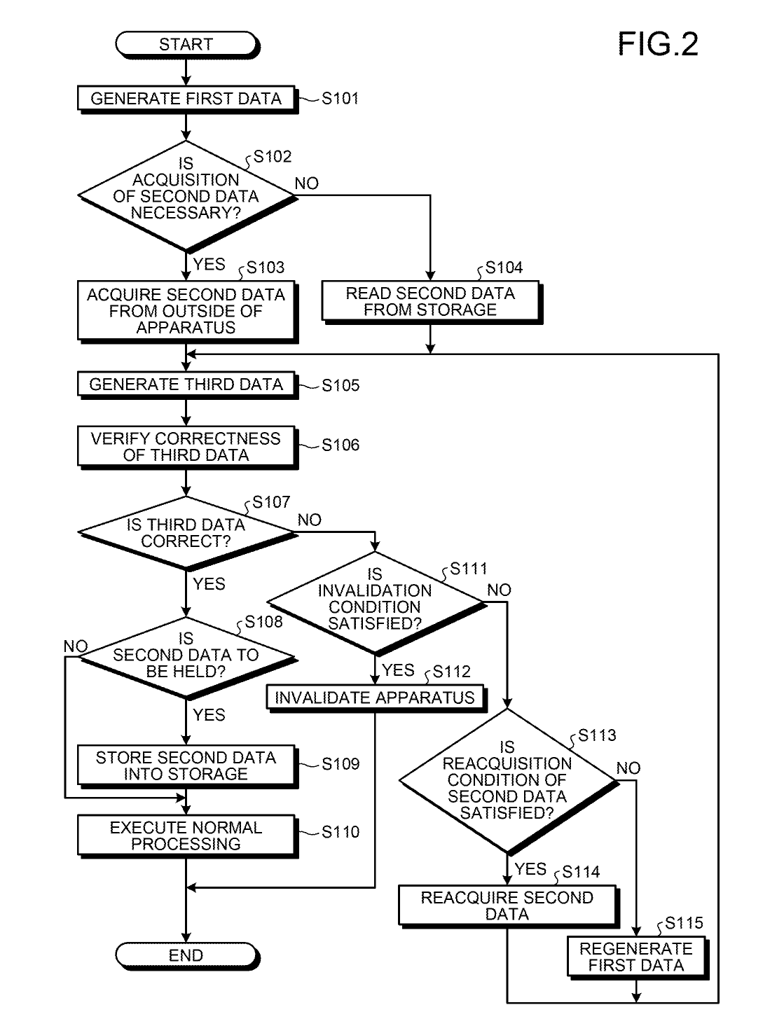

Next, with reference to FIG. 2, an operation of the data generation apparatus 10A of the present embodiment will be described. FIG. 2 is a flowchart illustrating an example of a processing procedure in the data generation apparatus 10A of the present embodiment.

When processing in the data generation apparatus 10A is started, the first generator 11 first generates first data unique to the apparatus (step S101).

Next, the first determination unit 12 determines whether acquisition of second data is necessary (step S102). When it is determined that acquisition of second data is necessary (step S102: Yes), the acquisition unit 13 acquires second data from the outside of the apparatus (step S103). On the other hand, when it is determined that acquisition of second data is not necessary (step S102: No), the storage controller 16 reads second data from the storage 20A (step S104).

Note that an order of the processing in step S101 and processing in step S102 to step S104 may be opposite. That is, after acquisition of second data by the acquisition unit 13 or reading of second data by the storage controller 16 is performed, generation of first data by the first generator 11 may be performed.

Next, the second generator 14 generates third data by using the first data generated in step S101 and the second data acquired from the outside of the apparatus in step S103 or the second data read from the storage 20A in step S104 (step S105).

Next, for example, by the above-described method, the verifier 17 verifies correctness of the third data generated in step S105 (step S106). Then, when it is determined that the third data generated in step S105 is correct by the verification in step S106 (step S107: Yes), the second determination unit 15 determines that second data used for generation of the third data is to be held in the apparatus (step S108). Then, when it is determined that the second data is to be held (step S108: Yes), the storage controller 16 stores the second data used for generation of the third data in step S105 into the storage 20A (step S109). On the other hand, when it is determined that the second data is not to be held (step S108: No) or when second data used for generation of the third data in step S105 is second data read from the storage 20A in step S104, the second data is not stored into the storage 20A.

Then, in the data generation apparatus 10A, normal processing using the third data generated in step S105 is executed (step S110). Here, for example, when the third data is an identifier, the normal processing is authentication processing or the like based on the identifier and when the third data is an encryption key, the normal processing is encryption communication or the like using the encryption key.

On the other hand, when it is determined by the verification processing in the step S106 that the third data generated in step S105 is not correct (step S107: No), the processing selector 18A determines whether the above-described invalidation condition is satisfied (step S111). Then, when the invalidation condition is satisfied (step S111: Yes), the processing selector 18A selects invalidation of an apparatus as the following processing. As a result, the data generation apparatus 10A is invalidated (step S112).

On the other hand, when the invalidation condition is not satisfied (step S111: No), the processing selector 18A determines whether the above-described second data reacquisition condition is satisfied (step S113). Then, when the second data reacquisition condition is satisfied (step S113: Yes), the processing selector 18A selects reacquisition of second data as the following processing. As a result, reacquisition of second data is performed (step S114). Then, the processing goes back to step S105 and processing thereafter is repeatedly performed.

On the other hand, when the second data reacquisition condition is not satisfied (step S113: No), the processing selector 18A selects regeneration of first data as the following processing. As a result, first data unique to the apparatus is regenerated by the first generator 11 (step S115). Then, the processing goes back to step S105 and processing thereafter is repeatedly performed.

As described above, instead of acquiring second data from the outside of the apparatus each time processing using third data is executed, the data generation apparatus 10A of the present embodiment determines whether acquisition of second data is necessary and acquires the second data from the outside of the apparatus only when it is determined that acquisition is necessary. Thus, according to the data generation apparatus 10A of the present embodiment, third data is generated in a short period of time and a period of time until processing using the third data is executed can be reduced.

The data generation apparatus 10A of the present embodiment verifies correctness of the generated third data. When determining that the third data is not correct, the data generation apparatus 10A performs one kind of processing among of regeneration of first data, reacquisition of second data, and invalidation of an apparatus. Thus, according to the data generation apparatus 10A of the present embodiment, it can be made difficult to perform an attack to infer first data or third data by repeatedly inputting falsified second data.

### Second Embodiment

Next, the second embodiment will be described. In the second embodiment, exception processing using fourth data is added as a choice of processing of when it is determined that generated third data is not correct. In the following, the same reference sign is assigned to a configuration common to that of the first embodiment and an overlapped description is arbitrarily omitted. Only a characteristic part of the present embodiment will be described.

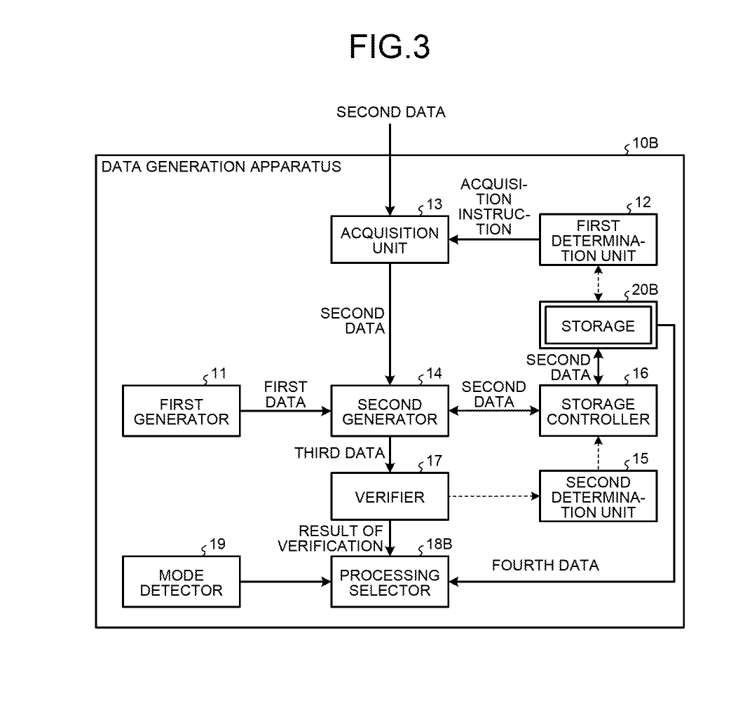

FIG. 3 is a block diagram illustrating a configuration example of a data generation apparatus 10B of the second embodiment. As illustrated in FIG. 3, the data generation apparatus 10B of the second embodiment includes a processing selector 18B and a storage 20B instead of the processing selector 18A and the storage 20A of the first embodiment. The data generation apparatus 10B of the second embodiment includes a mode detector 19 in addition to the configuration of the first embodiment. The other configuration is common to that of the data generation apparatus 10A (see FIG. 1) of the first embodiment.

In addition to second data used for generation of third data, the storage 20B stores fourth data. The fourth data is data temporarily used instead of third data, for example, during an operation in a fail-safe mode. In the present embodiment, an identifier used instead of third data in authentication processing, an encryption key used instead of third data in encryption communication, or the like is assumed as fourth data.

For example, as described later, the data generation apparatus 10B of the present embodiment can be embedded into a communication apparatus to be a node of a communication system mounted in a mobile object. In this case, when communication is performed between communication apparatuses to be nodes of a communication system, it is possible to increase safety of the communication by performing authentication processing or encryption communication by using third data. However, for example, in a case where a minimum operation is necessary such as a case where a mobile object with a trouble is moved to a maintenance factory, or when an urgent operation such as collision avoidance is necessary, certainty of an operation is more important than safety of communication. Thus, in the present embodiment, even when third data is not generated correctly, in a case where a predetermined condition (hereinafter, referred to as exception condition) is satisfied, processing in which a part of a function of normal processing using third data can be used, processing in which a function to change setting of an apparatus can be used, or the like (hereinafter, these kinds of processing will be referred to as exception processing) is performed by using fourth data instead of the third data.

In the following, a description will be made on the assumption that a system which includes the data generation apparatus 10B of the present embodiment being operating in a fail-safe mode is an exception condition. The fail-safe mode is an operation mode to ensure a minimum operation. Note that the above-described exception condition is an example and is not the limitation.

When a verifier 17 determines that third data generated by a second generator 14 is not correct, the processing selector 18B selects, according to a predetermined selection rule, at least one kind of processing among regeneration of first data, reacquisition of second data, invalidation of an apparatus, and exception processing using fourth data. For example, when the verifier 17 determines that third data generated by the second generator 14 is not correct, the processing selector 18B selects, as the following processing, exception processing using fourth data in a case where an exception condition is satisfied. When the verifier 17 determines that third data generated by the second generator 14 is not correct, the processing selector 18B selects invalidation of an apparatus as the following processing in a case where the exception condition is not satisfied and an invalidation condition is satisfied. When the verifier 17 determines that third data generated by the second generator 14 is not correct, the processing selector 18B selects reacquisition of second data as the following processing in a case where the exception condition is not satisfied and a second data reacquisition condition is satisfied. When the verifier 17 determines that third data generated by the second generator 14 is not correct, the processing selector 18B selects regeneration of first data as the following processing in a case where the exception condition and the second data reacquisition condition are not satisfied.

When an operation mode of the system including the data generation apparatus 10B is the fail-safe mode, the mode detector 19 detects this and gives a notification to the processing selector 18B. When a notification indicating that an operation mode of the system is the fail-safe mode is given, the processing selector 18B of the present embodiment determines that the exception condition is satisfied. Then, the processing selector 18B selects, as the following processing, exception processing using fourth data. As a result, fourth data stored in the storage 20B is read and exception processing using the fourth data is executed.

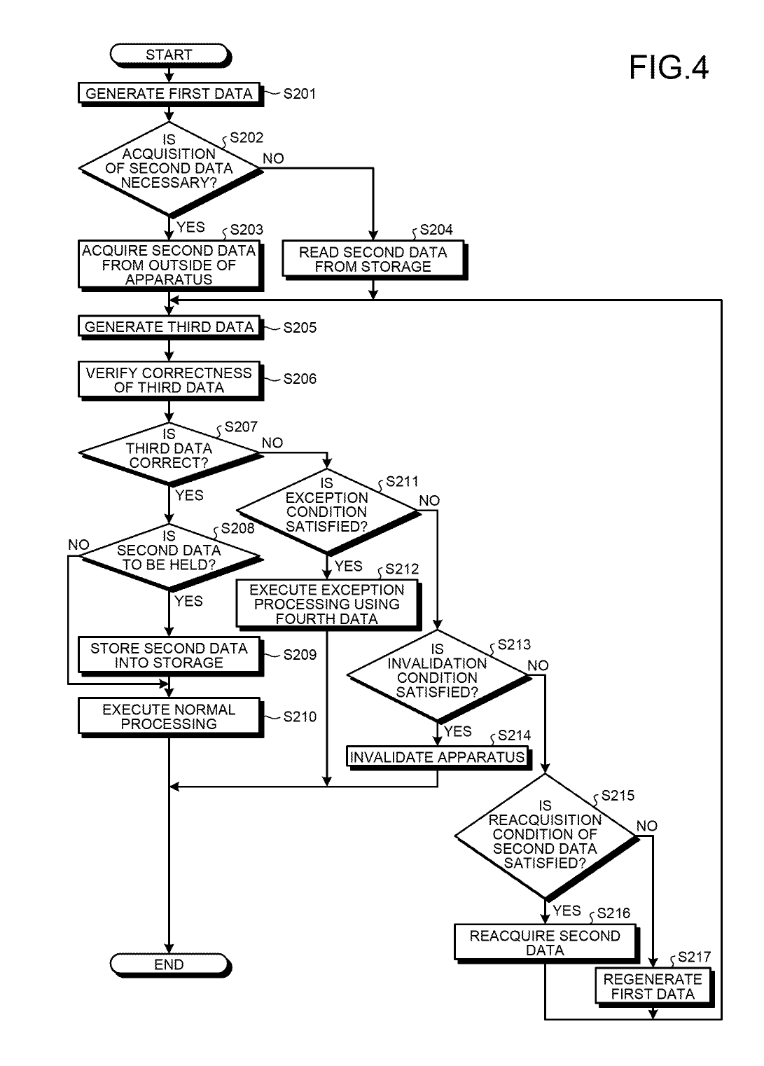

Next, with reference to FIG. 4, an operation of the data generation apparatus 10B of the second embodiment will be described. FIG. 4 is a flowchart illustrating an example of a processing procedure in the data generation apparatus 10B of the second embodiment. Note that processing in step S201 to step S210 in FIG. 4 is common to the processing in the data generation apparatus 10A of the first embodiment (processing in step S101 to step S110 in FIG. 2), and thus, a description thereof is omitted.

In the present embodiment, when it is determined by verification processing in step S206 that third data generated in step S205 is not correct (step S207: No), the processing selector 18B first determines whether the above-described exception condition is satisfied (step S211). Then, when the exception condition is satisfied (step S211: Yes), the processing selector 18B selects, as the following processing, exception processing using fourth data. As a result, fourth data is read from the storage 20B and exception processing using the fourth data is executed (step S212).

On the other hand, when the exception condition is not satisfied (step S211: No), the processing selector 18B determines whether the above-described invalidation condition is satisfied (step S213). Then, when the invalidation condition is satisfied (step S213: Yes), the processing selector 18B selects invalidation of an apparatus as the following processing. As a result, the data generation apparatus 10B is invalidated (step S214).

On the other hand, when the invalidation condition is not satisfied (step S213: No), the processing selector 18B determines whether the above-described second data reacquisition condition is satisfied (step S215). Then, when the second data reacquisition condition is satisfied (step S215: Yes), the processing selector 18B selects reacquisition of second data as the following processing. As a result, reacquisition of second data is performed (step S216). Then, the processing goes back to step S205 and processing thereafter is repeatedly performed.

On the other hand, when the second data reacquisition condition is not satisfied (step S215: No), the processing selector 18B selects regeneration of first data as the following processing. As a result, first data unique to the apparatus is regenerated by a first generator 11 (step S217). Then, the processing goes back to step S205 and processing thereafter is repeatedly performed.

As described above, when it is determined that generated third data is not correct, the data generation apparatus 10B of the present embodiment selects, as the following processing, exception processing using fourth data in a case where an exception condition such as a system being operating in the fail-safe mode is satisfied. Thus, according to the data generation apparatus 10B of the present embodiment, a minimum operation can be ensured.

Example of Application of Data Generation Apparatus

As described above, each of the data generation apparatus 10A of the first embodiment and the data generation apparatus 10B of the second embodiment which have been described above (hereinafter, collectively referred to as data generation apparatus 10 of embodiment) generates an identifier used for authentication processing, an encryption key used for encryption communication, or the like as third data (or fourth data temporarily used instead of third data). Thus, for example, by embedding the data generation apparatus 10 of the embodiment into a communication apparatus to perform authentication processing or encryption communication, safety of communication can be improved.

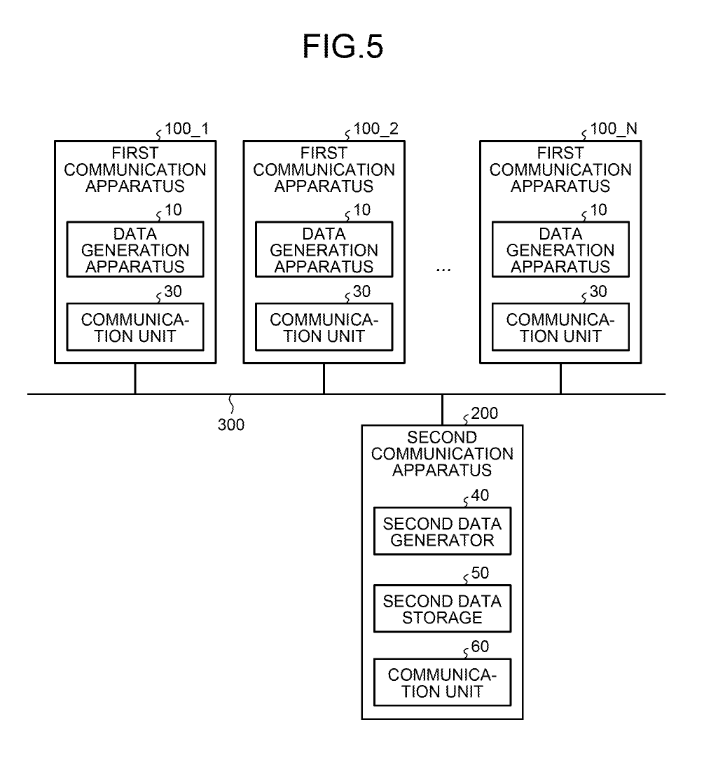

FIG. 5 is a schematic configuration view illustrating an example of a communication system including, as a node, a first communication apparatus 1000 which is a communication apparatus into which the data generation apparatus 10 of the embodiment is embedded. As illustrated in FIG. 5, in the communication system, a plurality of first communication apparatuses 100 (100_1, 100_2 . . . and 100_N) and a second communication apparatus 200 are connected, as nodes of a network, to a communication medium 300. The communication medium 300 may be a wired medium or a wireless medium.

The first communication apparatus 100 includes the data generation apparatus 10 of the embodiment and a communication unit 30.

The communication unit 30 communicates with a different first communication apparatus 100 by using third data (or fourth data) generated by the data generation apparatus 10. For example, when the data generation apparatus 10 generates an identifier of the first communication apparatus 100 as third data (or fourth data), the communication unit 30 transmits, for authentication processing to authenticate the first communication apparatus 100, an identifier generated by the data generation apparatus 10 to a different first communication apparatus 100. For example, when the data generation apparatus 10 generates an encryption key as third data (or fourth data), the communication unit 30 transmits an encrypted text, which is encrypted by using the encryption key, to a different first communication apparatus 100 or decodes an encrypted text, which is received from a different first communication apparatus 100, by using the encryption key. When second data is transmitted from the second communication apparatus 200, the communication unit 30 receives the second data and transmits the second data to the data generation apparatus 10. When the first communication apparatus 100 requests second data to the second communication apparatus 200, first data unique to an apparatus is acquired from the data generation apparatus 10 and transmitted to the second communication apparatus 200.

The second communication apparatus 200 is a communication apparatus to transmit second data to the first communication apparatus 100. The second communication apparatus 200 includes a second data generator 40, a second data storage 50, and a communication unit 60. The second communication apparatus 200 may generate second data according to a request from the first communication apparatus 100 and transmit the second data to the first communication apparatus 100 or may transmit previously-stored second data to the first communication apparatus 100. When second data is generated according to a request from the first communication apparatus 100 and transmitted to the first communication apparatus 100, the second communication apparatus 200 does not necessarily include the second data storage 50. When the previously-stored second data is transmitted to the first communication apparatus 100, the second communication apparatus 200 does not necessarily include the second data generator 40.

The second data generator 40 is a processing function which operates in a case where second data is generated and transmitted to the first communication apparatus 100 by the second communication apparatus 200 according to a request from the first communication apparatus 100. In a case of requesting second data to the second communication apparatus 200, the first communication apparatus 100 transmits first data, which is unique to the apparatus, to the second communication apparatus 200. The first data transmitted by the first communication apparatus 100 is received by the communication unit 60 of the second communication apparatus 200. By using the first data received by the communication unit 60, the second data generator 40 generates (calculates) second data to generate third data from the first data. The second data generated by the second data generator 40 is transmitted to a first communication apparatus 100, which is a source of request, through the communication unit 60.

Here, when third data is an encryption key (shared key) shared by a plurality of first communication apparatuses 100, by using pieces of first data transmitted from the plurality of first communication apparatuses 100 and received by the communication unit 60, the second data generator 40 generates (calculates) a plurality of pieces of second data to generate common third data from the pieces of first data. The pieces of second data generated by the second data generator 40 are respectively transmitted to the plurality of first communication apparatuses 100 through the communication unit 60.

Here, it is not necessary to synchronize timing at which the data generation apparatuses 10 of the plurality of first communication apparatuses 100 respectively acquire the pieces of second data from the second communication apparatus 200 through the communication unit 30. For example, each data generation apparatus 10 may independently determine timing to acquire second data from the second communication apparatus 200 through the communication unit 30. Alternatively, the second communication apparatus 200 may determine timing at which each data generation apparatus 10 acquires second data individually. Accordingly, when the plurality of first communication apparatuses 100 respectively acquires pieces of second data from the second communication apparatus 200, it is possible to distribute a load of the communication unit 60 of the second communication apparatus 200 and to reduce a waiting state of each of the first communication apparatuses 100.

The second data storage 50 stores previously-generated second data. In order to generate second data, first data unique to the data generation apparatus 10 of the first communication apparatus 100 is necessary. Here, for example, a vendor to provide the first communication apparatus 100 can acquire first data, which is unique to an apparatus, from the data generation apparatus 10 embedded into the first communication apparatus 100 and can previously generate (calculate) second data by using the first data. By storing the second data which is generated previously in such a manner into the second data storage 50 of the second communication apparatus 200, the second communication apparatus 200 can transmit the second data to the first communication apparatus 100 without generating second data with the second data generator 40. Note that when third data is an encryption key (shared key) to be shared by the plurality of first communication apparatuses 100, first data is acquired from the data generation apparatus 10 embedded to each of the first communication apparatuses 100. Second data is previously generated by using the plurality of pieces of first data and is stored into the second data storage 50 of the second communication apparatus 200.

When first data is transmitted from the first communication apparatus 100, the communication unit 60 receives the first data and transmits the first data to the second data generator 40. The communication unit 60 transmits, to the first communication apparatus 100, second data generated by the second data generator 40 or second data read from the second data storage 50. Here, the communication unit 60 may add, to the second data, identification information of a first communication apparatus 100 to be a transmission destination of the second data and may transmit (broadcast) the data to a network (communication medium 300). In this case, based on the identification information added to the second data transmitted to the network, each first communication apparatus 100 connected to the network determines whether the second data is transmitted to itself. Then, when the second data is transmitted to itself, the second data is received by the communication unit 30.

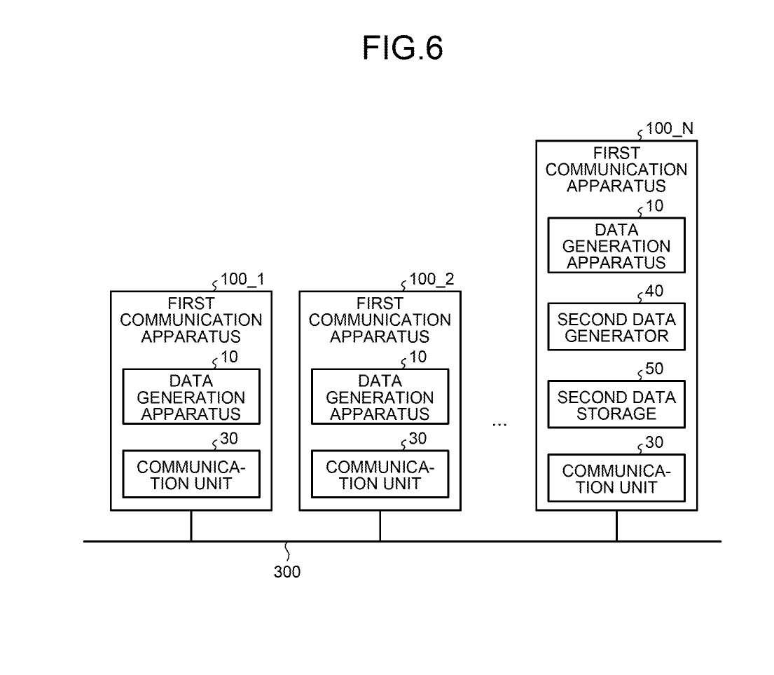

Note that in the communication system illustrated as an example in FIG. 5, the second communication apparatus 200 to transmit second data to the first communication apparatuses 100 is configured as an apparatus independent from the plurality of first communication apparatuses 100. However, a function of the second communication apparatus 200 may be included in at least one of the plurality of first communication apparatuses 100. FIG. 6 is a schematic configuration view illustrating an example of the communication system in this case. In the example in FIG. 6, a first communication apparatus 100_N among the plurality of first communication apparatuses 100 connected to the communication medium 300 as nodes of the network includes a function as the second communication apparatus 200. That is, the first communication apparatus 100_N illustrated in FIG. 6 includes (at least one of) a second data generator 40 and a second data storage 50 in addition to a data generation apparatus 10 and a communication unit 30. The communication unit 30 of the first communication apparatus 100_N includes a function as the communication unit 60 of the second communication apparatus 200 in addition to a function as the communication unit 30 of the first communication apparatus 100. In a case of the example, a first communication apparatus 100 other than the first communication apparatus 100_N acquires second data from the first communication apparatus 100_N during communication with a different first communication apparatus 100.

The communication system described above can be used, for example, as a communication network built in a mobile object (such as automobile, railroad vehicle, airplane, or ship) by being mounted on the mobile object.

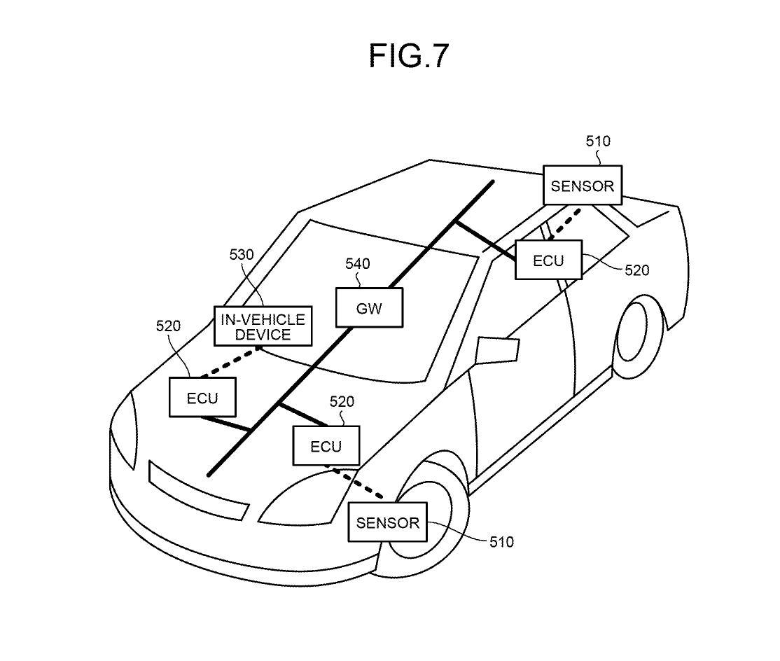

In each of many recent mobile objects, a communication network to exchange information between devices is built in order to realize a cooperative operation by a plurality of devices. For example, as illustrated as an example in FIG. 7, in an automobile, a sensor 510 to collect various kinds of information, an electronic control unit (ECU) 520 to control an operation of each unit by using information collected from the sensor 510, an in-vehicle device 530 an operation of which is controlled by the ECU 520, and a communication network including, as a node, a gateway (GW) 540 to control a network are built. Here, for a safe operation of the automobile, it is necessary that communication between the sensor 510 and the ECU 520, that between a plurality of different ECUs 520 (through GW 540), and that between the ECU 520 and the in-vehicle device 530 are performed appropriately. That is, it is preferable that the sensor 510 and the ECU 520, the plurality of ECUs 520, and the ECU 520 and the in-vehicle device 530 authenticate correctness of each other and protect communication contents (falsification prevention or keeping secret), for example, by encryption communication. For such authentication and protection of communication contents, the above-described identifier or encryption key is necessary.

On the other hand, since being owned by a user, the sensor 510, the ECU 520, the in-vehicle device 530, the GW 540 or the like may be a target of illegal analysis. Thus, when information (third data) such as the above-described identifier or encryption key is stored, for example, into a non-volatile memory, there is a case where the information is analyzed illegally and communication between the sensor 510 and the ECU 520, that between the plurality of ECUs 520, and that between the ECU 520 and the in-vehicle device 530 are falsified or sniffed.

By configuring the sensor 510, the ECU 520, the in-vehicle device 530, the GW 540 or the like as the above-described first communication apparatus 100, it becomes possible to protect the sensor 510, the ECU 520, the in-vehicle device 530, the GW 540, or the like from illegal analysis. For example, a case where the plurality of ECUs 520 is configured as the first communication apparatuses 100 and communication is performed between the plurality of ECUs 520 is considered. In this case, the GW 540 is configured as the second communication apparatus 200 and second data is transmitted to each of the plurality of ECUs 520. By receiving the second data transmitted from the GW 540 and inputting the received second data into an included data generation apparatus 10, each of the plurality of ECUs 520 can generate third data. Then, by using the third data, it is possible to perform communication between the plurality of ECUs 520 safely.

A case where the sensor 510 is configured as the above-described first communication apparatus 100 and the ECU 520 is configured as the first communication apparatus 100 (first communication apparatus 100_N illustrated in FIG. 6) further including a function of the second communication apparatus 200 and where communication is performed between the sensor 510 and the ECU 520 is considered. In this case, when the sensor 510 needs third data, the ECU 520 transmits second data to the sensor 510. By receiving the second data transmitted from the ECU 520 and inputting the received second data into an included data generation apparatus 10, the sensor 510 can generate third data. Then, by using the third data, it is possible to perform communication with the ECU 520 safely.

Note that an example of the automobile illustrated in FIG. 7 is not the limitation. By configuring each of various devices to be nodes of a communication network built in a mobile object as the above-described first communication apparatus 100, authentication and communication protection between the various devices mounted in the mobile object are realized and safety and efficiency of traveling of the mobile object can be improved.

Supplemental Description

The data generation apparatus 10 of the embodiment can be realized, for example, by a cooperative operation of hardware and software. In this case, as the data generation apparatus 10 of the embodiment, for example, a hardware configuration as a general computer system including a processor such as a CPU, a main memory such as a RAM, various auxiliary memories, and the like is employed. By using the main memory, the processor executes a program provided as software. Thus, the above-described functional components (first generator 11, first determination unit 12, acquisition unit 13, second generator 14, second determination unit 15, storage controller 16, verifier 17, processing selector 18A and 18B, and mode detector 19) in the data generation apparatus 10 of the embodiment are realized. Each of the storages 20A and 20B in the apparatus are realized by using a rewritable auxiliary memory.

A program to realize a functional component of the data generation apparatus 10 of the embodiment is provided, for example, by being embedded in a ROM. The program may be provided by being recorded, as a file in a format which can be installed or executed, in a computer-readable recording medium such as a CD-ROM, a flexible disk (FD), a CD-R, or a digital versatile disc (DVD). The above program may be stored in a computer connected to a network such as the Internet and may be provided by being downloaded through the network. The above program may be provided or distributed through a network such as the Internet.

The above program includes, for example, a module configuration including a component corresponding to each of the above-described functional components in the data generation apparatus 10 in the embodiment. For example, a processor such as a CPU reads and executes a program, which is stored in an auxiliary memory such as a ROM, by using a main memory such as a RAM, whereby the each of the above components is loaded into the main memory and each of the above-described functional components in the data generation apparatus 10 of the embodiment is generated in the main memory.

Note that a part or the whole of the above-described functional components in the data generation apparatus 10 of the embodiment can be realized by special hardware such as an application specific integrated circuit (ASIC) or a field-programmable gate array (FPGA).

While a certain embodiments have been described, these embodiments have been presented by way of example only, and are not intended to limit the scope of the inventions.

Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A data generation apparatus comprising:
a first generator to generate first data unique to an apparatus;
a first determination unit to determine whether acquisition of second data is necessary according to a predetermined condition;
an acquisition unit to acquire the second data from an outside of the apparatus when it is determined that acquisition of the second data is necessary;
a second generator to generate third data by using the first data and the second data; and
a storage controller to store, into a storage, the second data that has been used for generation of the third data, wherein
when it is determined that acquisition of the second data is not necessary, the second generator generates the third data by using the first data and the second data stored in the storage.

2. The apparatus according to claim 1, wherein the first determination unit determines that acquisition of the second data is necessary in a case where the second data is not stored in the storage.

3. The apparatus according to claim 2, wherein even when second data is stored in the storage, the first determination unit determines that acquisition of the second data is necessary in a case where a period of time passed since the second data is stored into the storage exceeds a first threshold.

4. The apparatus according to claim 2, wherein even when second data is stored in the storage, the first determination unit determines that acquisition of the second data is necessary in a case where the number of times the third data is generated by using the second data stored in the storage exceeds a second threshold.

5. The apparatus according to claim 2, wherein even when the second data is stored in the storage, the first determination unit determines that acquisition of the second data is necessary in a case where an instruction to acquire the second data is received from the outside of the apparatus.

6. The apparatus according to claim 2, wherein even when second data is stored in the storage, the first determination unit determines that acquisition of the second data is necessary in a case where a difference between statistical information of first data that has been used for generation of the third data immediately after the second data is stored into the storage and statistical information of first data that has been used for recent generation of the third data exceeds a third threshold.

7. The apparatus according to claim 1, further comprising a second determination unit to determine, according to a predetermined condition, whether to hold the second data which has been acquired from the outside of the apparatus and has been used for generation of the third data, wherein
the storage controller stores the second data, which has been acquired from the outside of the apparatus and which has been used for generation of the third data, into the storage when it is determined that the second data is to be held.

8. The apparatus according to claim 7, wherein the second determination unit determines that the second data is not to be held in a case where it is not possible to hold operation time or consumed power to store the second data into the storage.

9. The apparatus according to claim 7, further comprising a verifier to verify correctness of the third data, wherein the second determination unit determines that the second data is not to be held in a case where it is determined that the third data is not correct.

10. The apparatus according to claim 1, further comprising:
a verifier to verify correctness of the third data; and
a processing selector to select at least one kind of processing, according to a predetermined selection rule, among regeneration of the first data, reacquisition of the second data, and invalidation of the apparatus in a case where it is determined that the third data is not correct.

11. The apparatus according to claim 1, further comprising:
a verifier to verify correctness of the third data; and
a processing selector to select at least one kind of processing, according to a predetermined selection rule, among regeneration of the first data, reacquisition of the second data, invalidation of the apparatus, and processing using fourth data in a case where it is determined that the third data is not correct.

12. The apparatus according to claim 1, wherein the first generator generates the first data by using a physically unclonable function.

13. A communication apparatus comprising:
the data generation apparatus according to claim 1; and
a communication unit to communicate with an external apparatus by using the third data generated by the second generator.

14. A communication system comprising:
one or more first communication apparatuses each of which includes:
the data generation apparatus according to claim 1; and
a communication unit to communicate with an external apparatus by using the third data generated by the second generator; and
a second communication apparatus to transmit the second data to the first communication apparatus.

15. The system according to claim 14, wherein
a plurality of first communication apparatuses is connected to a same network, and
the second communication apparatus adds, to the second data, identification information of the first communication apparatus to be a transmission destination of the second data and transmits the data to the network.

16. The system according to claim 14, wherein the second data is data calculated based on a plurality of pieces of first data, which is respectively generated in the plurality of data generation apparatuses respectively included in the plurality of first communication apparatuses, in such a manner that the plurality of data generation apparatuses generate same third data.

17. A mobile object comprising:
the communication system according to claim 14.

18. A data generation method executed in a data generation apparatus, comprising:
generating, with a first generator, first data unique to an apparatus;
determining, with a first determination unit, whether acquisition of second data is necessary according to a predetermined condition;
acquiring the second data from an outside of the apparatus, with a data acquisition unit, when it is determined that acquisition of the second data is necessary;
generating third data with a second generator by using the first data and the second data; and
storing, with a storage controller, the second data that has been used for generation of the third data into a storage, wherein
the second generator generates the third data by using the first data and the second data, which is stored in the storage, when it is determined that acquisition of the second data is not necessary.

19. A computer program product comprising a computer-readable medium including programmed instructions, wherein the instructions, when executed by a computer, cause the computer to function as:
a first generator to generate first data unique to an apparatus;
a first determination unit to determine whether acquisition of second data is necessary according to a predetermined condition;
an acquisition unit to acquire the second data from an outside of the apparatus when it is determined that acquisition of the second data is necessary;
a second generator to generate third data by using the first data and the second data; and
a storage controller to store, into a storage, the second data that has been used for generation of the third data, wherein
when it is determined that acquisition of the second data is not necessary, the second generator generates the third data by using the first data and the second data stored in the storage.
